(19) United States
(12) Patent Application Publication
(10) Pub. No.: US 2022/0343641 A1
(43) Pub. Date: Oct. 27, 2022

(54) DEVICE AND METHOD FOR PROCESSING DATA OF A NEURAL NETWORK

(71) Applicant: Robert Bosch GmbH, Stuttgart (DE)

(72) Inventors: Armin Runge, Pittsburgh, PA (US); Thomas Wenzel, Hamburg (DE)

(21) Appl. No.: 17/762,954

(22) PCT Filed: Aug. 10, 2020
(86) PCT No.: PCT/EP2020/072403

§ 371 Date: Mar. 23, 2022

(30) Foreign Application Priority Data
Oct. 2, 2019 (DE) 10 2019 215 255.4

(51) Int. Cl. G06V 10/82; G06V 10/764; G06V 10/776

(52) U.S. Cl. CPC G06V 10/82; G06V 10/764; G06V 10/776

(57) ABSTRACT

A device and method for processing data, in particular unnormalized, multidimensional data, of a neural network, in particular a deep neural network, especially for detecting objects in an input image. The data includes at least one first classification value for a multitude of positions in the input image in each case, a classification value quantifying a presence of a class. The method includes the following steps: evaluating the data as a function of a threshold value, a first classification value for a respective position in the input image that lies either below or above the threshold value being discarded, and a first classification value for a respective position in the input image that lies either above or below the threshold value not being discarded.

### FIELD

The present invention relates to a computer-implemented method for processing data, in particular unnormalized, multidimensional data, of a neural network, in particular a deep neural network.

In addition, the present invention relates to a device for processing data, in particular unnormalized, multidimensional data, of a neural network, in particular a deep neural network.

### BACKGROUND INFORMATION

Neural networks, especially convolutional neural networks, are frequently used in the field of image processing, in particular for an object detection. The structure of such a network is basically made up of multiple convolutional layers.

For an object detection in such a network, a decision is made about the presence of classes, in particular target object classes, for a multitude of positions in an input image. A multitude, e.g., up to 10⁷ decisions per input image, is made in this way. Based on these decisions, a final network output of the neural network then is able to be calculated, which is also known as a prediction.

In what is referred to as a bounding box method, the prediction for an object is usually processed in such a way that a so-called bounding box, i.e., a box surrounding the object, is calculated for a detected object. The coordinates of the bounding box correspond to the position of the object in the input image. At least one probability value of an object class is output for the bounding box.

In the so-called semantic segmentation, classes are allocated to pixels of the input image pixel by pixel or superpixel by superpixel. In this context, superpixel by superpixel refers to multiple combined pixels. A pixel has a certain position in the input image.

Even smaller networks of this type may already have several million parameters and require several billion computing operations for a single execution. Especially when neural networks are to be used in embedded systems, both the required memory bandwidth and the number of required computing operations are frequently limiting factors.

Conventional compression methods are often not suitable for reducing the required memory bandwidth on account of the characteristic frequency distribution of the final network output of a neural network.

It would be desirable to provide a method which is able to reduce both the number of required computing operations and a required memory bandwidth.

### SUMMARY

Preferred embodiments of the present invention relate to a computer-implemented method for processing data, in particular unnormalized, multidimensional data, of a neural network, in particular a deep neural network, especially for detecting objects in an input image, the data including at least one first classification value for a multitude of positions in the input image in each case, a classification value quantifying a presence of a class, and the method includes the following steps: evaluating the data as a function of a threshold value, a first classification value for a respective position in the input image that lies either below or above the threshold value being discarded, and a first classification value for a respective position in the input image that lies either above or below the threshold value not being discarded.

For example, a first classification value is the unnormalized result of a filter, in particular a convolutional layer, of the neural network. A filter trained to quantify the presence of a class will also be referred to as a class filter in the following text. It is therefore provided to evaluate the unnormalized results of the class filters and to discard the results of the class filters as a function of a threshold value.

In further preferred embodiments of the present invention, it is provided that the threshold value is zero and a first classification value for a respective position in the input image that lies below the threshold value is discarded, and a first classification value for a respective position in the input value that lies above the threshold value is not discarded. It is therefore provided to discard negative classification values and not to discard positive classification values.

In further preferred embodiments of the present invention, it is provided that the discarding of a first classification value for a respective position in the input image furthermore includes: setting the first classification value to a fixed value, in particular zero. The fixed value preferably is a randomly specifiable value. The fixed value is preferably zero. A compression method such as a run length encoding method may then be applied to the classification values. Since the unnormalized, multidimensional data of the neural network predominantly include this fixed value once the first classification values have been set to the fixed value, in particular zero, high compression rates are achievable, in particular of 10³-10⁴.

In additional preferred embodiments of the present invention, it is provided that the first classification value is the unnormalized result of a class filter of the neural network, in particular for a background class, for a respective position in the input image, and the discarding of a first classification value for a respective position in the input image includes the discarding of the result of the class filter.

In further preferred embodiments of the present invention, it is provided that the data for the respective position in the input image include at least one further classification value and/or at least one value for an additional attribute, and the further classification value includes the unnormalized result of a class filter for an object class, in particular a target object class, and the method furthermore includes: discarding the at least one further classification value and/or the at least one value for an additional attribute for a respective position as a function of whether the first classification value for the respective position is discarded. A value for an additional attribute, for example, includes a value for a relative position.

In additional preferred embodiments of the present invention, it is provided that the discarding of the at least one further classification value also includes: setting the further classification value and/or the value for an additional attribute to a fixed value, in particular zero. A compression method such as a run length encoding method is then able to be applied to the classification values. Since after the first and further classification values and/or the values for an additional attribute have been set to a fixed value, in particular zero, the unnormalized, multidimensional data of the neural network predominantly include this fixed value, so that high compression rates are achievable, in particular of 10³-10⁴.

In further preferred embodiments of the present invention, it is provided that the method furthermore includes: processing the non-discarded classification values, in particular forwarding the non-discarded classification values and/or applying an activation function, in particular a Softmax activation function, to the non-discarded classification values. By applying an activation function, it is then possible to calculate a final network output of the neural network, also known as a prediction, based on the non-discarded classification values, in particular in order to predict whether and/or at what probability an object in a certain class is located at a particular position in the input image.

Additional preferred embodiments of the present invention relate to a device for processing data, in particular unnormalized, multidimensional data, of a neural network, in particular a deep neural network, especially for detecting objects in an input image, the data including at least one first classification value for a multitude of positions in the input image, and the device being developed to carry out the method according to the embodiments.

In additional preferred embodiments of the present invention, it is provided that the device includes a computing device, in particular a processor, as well as a memory for at least one artificial neural network, which are designed to execute a method according to the claims.

Further preferred embodiments of the present invention relate to a system for detecting objects in an input image, which includes a device for processing data, in particular unnormalized, multidimensional data, of a neural network according to the embodiments, the system furthermore including a computing device for applying an activation function, in particular a Softmax application function, especially for calculating a prediction of the neural network, and the device is designed to forward the non-discarded classification values to the computing device and/or to a memory device allocated to the computing device.

Additional preferred embodiments of the present invention relate to a computer program, which includes computer-readable instructions that run the method according to the embodiments when the instructions are executed by a computer.

Further preferred embodiments of the present invention relate to a computer program product which includes a memory in which a computer program according to the embodiments is stored.

Additional preferred embodiments of the present invention relate to a use of the method according to the embodiments and/or a neural network according to the embodiments, and/or a device according to the embodiments, and/or a system according to the embodiments, and/or a computer program according to the embodiments, and/or a computer program product according to the embodiments for the at least partly autonomous moving of a vehicle, and an input image is acquired by a sensor system, in particular a camera, radar sensor or lidar sensor, of the vehicle, and a method according to the embodiments is carried out for the input image for detecting objects, and at least one actuation is determined for the vehicle, in particular for automated braking, steering or accelerating of the vehicle, as a function of the result of the object detection.

Further preferred embodiments of the present invention relate to a use of the method according to the embodiments, and/or of a neural network according to the embodiments, and/or of a device according to the embodiments, and/or of a system according to the embodiments, and/or of a computer program according to the embodiments, and/or of a computer program product according to the embodiments for moving a robot system or parts thereof, and an input image is acquired by a sensor system, in particular a camera, of the robot system, and a method according to the embodiments is carried out for the input image for detecting objects, and at least one actuation of the robot system, in particular for an interaction with objects in the environment of the robot system, is determined as a function of the result of the object detection.

Additional advantageous embodiments of the present invention result from the following description and the figures.

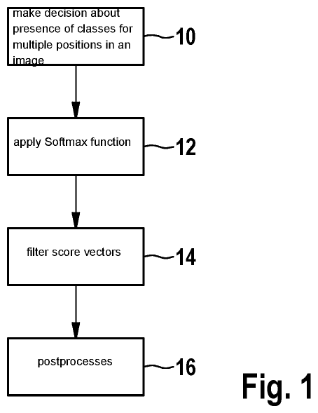

FIG. 1 shows steps of a conventional method for an object detection.

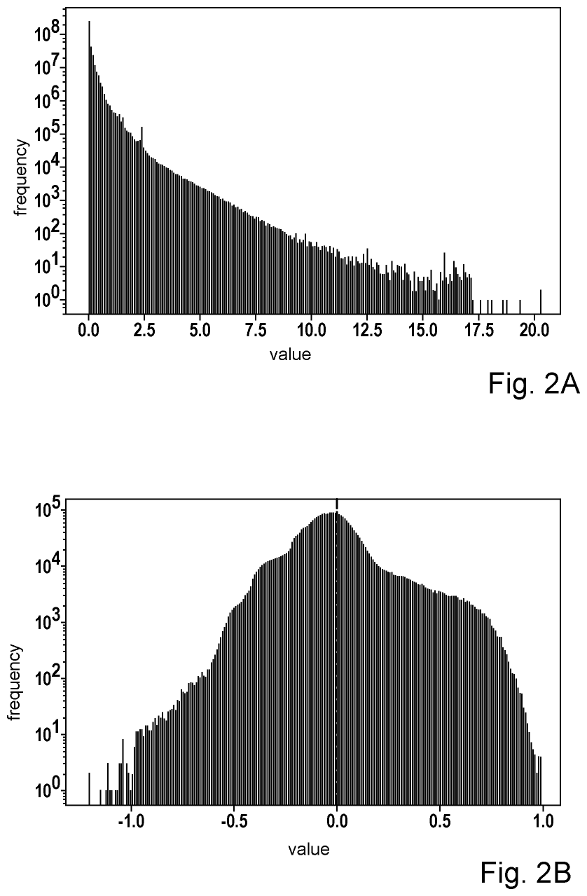

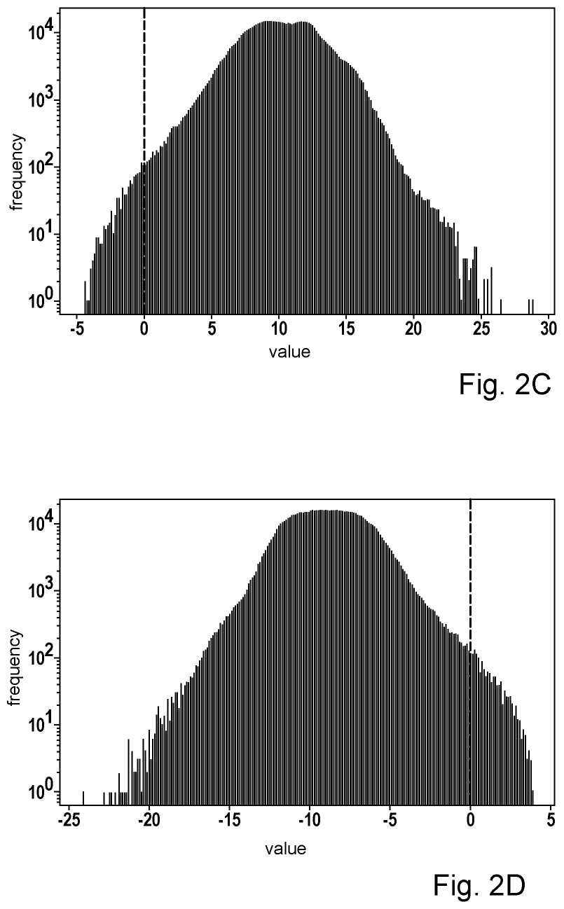

FIG. 2A shows a typical frequency distribution of the results of a convolutional layer of a neural network for an object detection.

FIG. 2B shows typical frequency distribution of unnormalized data including a first and a further classification value.

FIG. 2C shows typical frequency distribution of unnormalized data including the first classification value.

FIG. 2D shows a typical frequency distribution of unnormalized data including the further classification value.

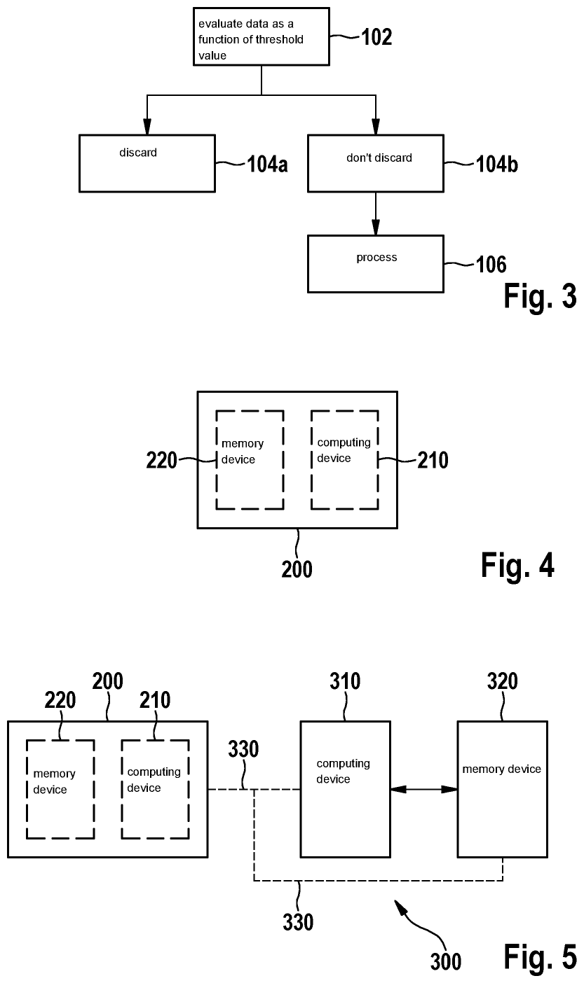

FIG. 3 shows steps of a method for processing data, in accordance with an example embodiment of the present invention.

FIG. 4 shows a schematic representation of a device for processing data, in accordance with an example embodiment of the present invention.

FIG. 5 shows a schematic representation of a system for processing data, in accordance with an example embodiment of the present invention.

### DETAILED DESCRIPTION OF EXAMPLE EMBODIMENTS

FIG. 1 schematically shows steps of a conventional method for an object detection. A so-called convolutional neural network is commonly used for this purpose. As a rule, a structure of such a network includes multiple convolutional layers. Filters of the convolutional layers are trained to quantify the presence of a class, for instance. Such filters are also denoted as class filters in the following text. In a step 10, using class filters, a decision is made about the presence of classes, in particular a background class and/or a target object class, for a multitude of positions in an input image. Hereinafter, the results of the class filters are also referred to as classification values.

Then, in a step 12, the Softmax function for determining a probability at which an object of a certain class is situated at a respective position is applied to each of the positions across the results of the class filters, also referred to as unnormalized, multidimensional data or raw scores. The use of the Softmax function normalizes the raw scores to the interval [0, 1] so that the so-called score vector is produced for each one of the positions. The score vector usually has an entry for each target object class and an entry for the background class. Next, in a further step 14, the score vectors in which an entry of the score vector for a target object class is greater than a predefined threshold are filtered out by what is known as score thresholding.

Additional steps for postprocessing include, for instance, the calculation of object boxes and the application of further standard methods, e.g., a non-maximal suppression, in order to produce final object boxes. These postprocessing steps are combined by way of example in step 16.

Most computing devices for neural networks, in particular hardware accelerators, are not suitable for executing steps 12 through 16. For this reason, all unnormalized data, including the classification values, must then be transmitted to a further memory device in order to be further processed by another computing device suitable for this purpose.

The transmission of all data and the application of the mentioned postprocessing steps require both a high memory bandwidth and a large number of necessary computing operations.

FIG. 2B shows a typical frequency distribution of unnormalized data including a first and a further classification value. The first classification value, for example, is the result of a class filter for the background class. The further classification value is the result of a class filter for the target object class of pedestrians, for instance.

Methods for reducing the memory bandwidth, e.g., based on a loss-free or also a loss-including compression such as run length encoding are already available in the related art. Such approaches are able to be applied to the results of a convolutional layer, for instance. FIG. 2A shows a typical frequency distribution of the results of a convolutional layer of a neural network. Because of the frequency distribution of the numerical values of the classification values, see FIG. 2B, such approaches do not function for the unnormalized data of the neural network.

FIG. 3 shows a computer-implemented method 100 for processing data, in particular unnormalized, multidimensional data, of a neural network, in particular a deep neural network, especially for detecting objects in an input image, the data including at least one first classification value for a multitude of positions in the input image in each case, and the method includes the following steps: evaluating 102 the data as a function of a threshold value, a first classification value for a respective position in the input image that lies either below or above the threshold value being discarded, 104a, and a first classification value for a respective position in the input image that lies either above or below the threshold value not being discarded, 104b.

The neural network, for example, operates according to the so-called bounding box method, and if an object is detected, a so-called bounding box is calculated, that is to say, a box surrounding the object. The coordinates of the bounding box correspond to the position of the object in the input image. At least one probability value of an object class is output for the bounding box.

The neural network may also operate according to the method of what is known as semantic segmentation, in which classes are allocated to pixels of the input image pixel by pixel or superpixel by superpixel. ‘Superpixel by superpixel’ in this context refers to multiple combined pixels. A pixel has a certain position in the input image.

An evaluation 102 of the unnormalized, multidimensional data, i.e., the raw scores of the neural network, is therefore performed in method 100 with the aid of a threshold value, also known as score thresholding.

In further embodiments, the first classification value is the unnormalized result of a class filter of the neural network, in particular for a background class, for a respective position in the input image, and the discarding 104a of a first classification value for a respective position in the input image includes the discarding of the result of the class filter.

For a first classification value, which is the result of a class filter of the background class and lies below or above a threshold value, it is thus assumed that a background and therefore no target object instance is present at this position in the input image. The classification values of the background class, considered on their own, thus already represent a valid decision boundary. A combination with further classification values of other class filters, as is the case in an application of the Softmax function, for instance, is not required. It may be gathered from FIGS. 2C and 2D that the unnormalized data of the class filter of the background class and the unnormalized data of the class filter of a target object class, e.g., pedestrians, are not independent.

The threshold value in particular may be zero. In this case, it can be advantageous that a first classification value for a respective position in the input image that lies below the threshold value is discarded, 104a, and a first classification value for a respective position in the input image that lies above the threshold value is not discarded, 104b.

In this aspect, it is provided that the first classification values, that is to say, the results of the class filter of the background class, are calibrated in such a way that the zero value defines the decision boundary starting from which it may be assumed that at a position having a classification value that lies below the threshold value, i.e., is negative, a background and thus no target object instance is present at this position in the input image. The calibration of the classification values takes place with the aid of the bias in the convolutional filter of the background class, for example.

It may furthermore be provided that the data for the respective position in the input image include at least one further classification value and/or at least one value for an additional attribute, and the further classification value includes the unnormalized result of a class filter for an object class, in particular a target object class, and the method furthermore includes: discarding the at least one further classification value and/or the at least one value for an additional attribute for a respective position as a function of whether the first classification value for the respective position is discarded. Thus, it is specifically provided to discard all results of the filters for a position as a function of the first classification value, in particular the result of the class filter of the background class.

In a further aspect, it is provided that the non-discarded classification values are processed in a step 106, in particular by forwarding the non-discarded classification values and/or by applying an activation function, in particular a Softmax activation function, to the non-discarded classification values. Thus, only the non-discarded classification values are forwarded and/or further processed. By applying the activation function, the prediction of the neural network can then be calculated based on the non-discarded classification values, especially in order to predict whether and at what probability an object in a certain class is situated in a certain position in the input image. By applying the activation function exclusively to non-discarded classification values and thus only to a portion of the classification values, the required computational operations for calculating a prediction are reduced.

In a further aspect, it may be provided that the original position of the non-discarded classification values are also forwarded when forwarding the non-discarded classification values. This is advantageous in particular for a determination of the position of the classification values in the input image. This means that instead of transmitting classification values for all positions, classification values and a position for a considerably lower number of positions are transmitted.

In a further aspect, it may be provided that the discarding 104a of a first classification value for a respective position in the input image furthermore includes: setting the first classification value to a fixed value, in particular zero. In this context, it may advantageously also be provided that the discarding of the at least one further classification value and/or the at least one value for an additional attribute also includes: setting the further classification value and/or the at least one value for an additional attribute to a fixed value, in particular zero.

Specifically, it is therefore provided to set all classification values and possibly further values for additional attributes for a position to a fixed value, in particular zero, as a function of the first classification value, in particular the result of the class filter of the background class. A compression method such as a run length encoding method may subsequently be applied to the classification values. Since the unnormalized, multidimensional data of the neural network predominantly include this fixed value after the classification values and/or the further values for additional attributes have been set to a fixed value, in particular zero, high compression rates are achievable, in particular of 10³-10⁴.

For instance, the described method 100 may be executed by a device 200 for processing data, in particular unnormalized, multidimensional data of a neural network, in particular a deep neural network, especially for detecting objects in an input image, the data including at least one first classification value for a multitude of positions in the input image, see FIG. 4.

Device 200 includes a computing device 210, in particular a hardware accelerator, and a memory device 220 for a neural network.

A further aspect relates to a system 300 for detecting objects in an input image, which includes a device 200 and a computing device 310 for applying an activation function, in particular a Softmax activation function, especially for calculating a prediction of the neural network. Device 200 is developed to forward the non-discarded classification values to computing device 310 and/or to a memory device 320 allocated to computing device 310. Data lines 330 connect these devices in the example, see FIG. 5

If computing device 210 for the neural network is not suitable to carry out step 106, then it is advantageous to forward the non-discarded classification values to computing device 310 and/or to a memory device 320 allocated to computing device 310.

The described method 100, described device 200 and described system 300, for example, are able to be used for the object detection, in particular a person detection, such as in the monitored area, in robotics or in the automotive sector.

Additional preferred embodiments relate to a use of method 100 according to the embodiments, and/or of a device 200 according to the embodiments, and/or of a system 300 according to the embodiments, and/or of a computer program according to the embodiments, and/or of a computer program product according to the embodiments for the at least partly autonomous moving of a vehicle, and an input image is acquired by a sensor system, in particular a camera, a radar sensor or lidar sensor, of the vehicle, and a method 100 according to the embodiments is carried out for the input image for the detection of objects, and at least one actuation for the vehicle, in particular for automated braking, steering or accelerating of the vehicle, is determined as a function of the result of the object detection.

Further preferred embodiments relate to a use of method 100 according to the embodiments, and/or of a device 200 according to the embodiments, and/or of a system 300 according to the embodiments, and/or of a computer program according to the embodiments, and/or of a computer program product according to the embodiments for moving a robot system or parts thereof, and an input image is acquired by a sensor system, in particular a camera, of the robot system, and a method 100 according to the embodiments is carried out for the input image for detecting objects, and at least one actuation of the robot system is determined as a function of the result of the object detection.

1-13. (canceled)

14. A computer-implemented method for processing data, the data being unnormalized, multidimensional data, of a deep neural network configured for detecting objects in an input image, the data including at least one first classification value for each of a multitude of positions in the input image, a classification value quantifying a presence of a class, the method comprising the following:
evaluating the data as a function of a threshold value, each first classification value for each respective position in the input image that lies either below or above the threshold value being discarded, and each first classification value for each respective position in the input image that lies either above or below the threshold value not being discarded.

15. The method as recited in claim 14, wherein the neural network is configured to detect objects in an input image.

16. The method as recited in claim 14, wherein the threshold value is zero and a respective first classification value for a respective position in the input image that lies below the threshold value is discarded, and a respective first classification value for the respective position in the input image that lies above the threshold value is not discarded.

17. The method as recited in claim 14, wherein the discarding of the respective first classification value for the respective position in the input image further includes: setting the respective first classification value to a fixed value, the fixed value being zero.

18. The method as recited in claim 14, wherein each first classification value is an unnormalized result of a class filter of the neural network, for a background class, for a respective position in the input image, and the discarding of a first classification value for a respective position in the input image includes discarding of a result of the class filter.

19. The method as recited in claim 14, wherein the data includes, for each respective position in the input image, at least one further classification value and/or at least one value for an additional attribute, and the further classification value includes the unnormalized result of a class filter for a target object class, and the method further includes: discarding the at least one further classification value and/or the at least one value for an additional attribute for a respective position as a function of whether the first classification value for the respective position is discarded.

20. The method as recited in claim 19, wherein the discarding of the at least one further classification value and/or the discarding of the at least one value for an additional attribute further includes: setting the further classification value and/or the value for an additional attribute to a fixed value, the fixed value being zero.

21. The method as recited in claim 14, wherein the method further includes:
processing the non-discarded classification values, including forwarding the non-discarded classification values and/or applying an activation function including a Softmax activation function to the non-discarded classification values.

22. A device for processing data, the data being unnormalized, multidimensional data, of a deep neural network configured for detecting objects in an input image, the data including at least one first classification value for each of a multitude of positions in the input image, a classification value quantifying a presence of a class, the device configured to:
evaluate the data as a function of a threshold value, each first classification value for each respective position in the input image that lies either below or above the threshold value being discarded, and each first classification value for each respective position in the input image that lies either above or below the threshold value not being discarded.

23. A system for detecting objects in an input image, the system comprising:
a device for processing data, the data being unnormalized, multidimensional data, of a deep neural network configured for detecting objects in an input image, the data including at least one first classification value for each of a multitude of positions in the input image, a classification value quantifying a presence of a class, the device configured to:
evaluate the data as a function of a threshold value, each first classification value for each respective position in the input image that lies either below or above the threshold value being discarded, and each first classification value for each respective position in the input image that lies either above or below the threshold value not being discarded; and
a computing device configured to applying an activation function including a Softmax activation function, for calculating a prediction of the neural network, and the device is configured to forward the non-discarded classification values to the computing device and/or to a memory device allocated to the computing device.

24. A non-transitory computer memory in which is stored a computer program for processing data, the data being unnormalized, multidimensional data, of a deep neural network configured for detecting objects in an input image, the data including at least one first classification value for each of a multitude of positions in the input image, a classification value quantifying a presence of a class, the computer program, when executed by a computer, causing the computer to perform the following:
evaluating the data as a function of a threshold value, each first classification value for each respective position in the input image that lies either below or above the threshold value being discarded, and each first classification value for each respective position in the input image that lies either above or below the threshold value not being discarded.

25. The method as recited in claim 14, wherein the method is used for at least partly autonomous moving of a vehicle, and the input image of the vehicle is acquired by a sensor system, including a camera or a radar sensor or a lidar sensor, of the vehicle, and the method is carried out for the input image for detecting objects, and at least one actuation for the vehicle, including for automated braking or steering or accelerating of the vehicle, is determined as a function of a result of the object detection.

26. The method as recited in claim 14, wherein the method is used for moving a robot system or parts of the robot system, and the input image is acquired by a sensor system including a camera, of the robot system, and the method is carried out for the input image for detecting objects, and at least one actuation for the robot system, is determined as a function of a result of the object detection.
